(19) United States
(12) Patent Application Publication
(10) Pub. No.: US 2018/0322199 A1
(43) Pub. Date: Nov. 8, 2018

(54) OPTIMIZING THE ALLOCATION OF JOBS ON JOB PORTAL

(71) Applicant: Propellum Infotech Pvt. Ltd., Andheri East, Mumbai (IN)

(72) Inventor: Richard Fernandes, Andheri East, Mumbai (IN)

(73) Assignee: Propellum Infotech Pvt. Ltd., Andheri East, Mumbai (IN)

(21) Appl. No.: 15/588,706

(22) Filed: May 8, 2017

(51) Int. Cl. G06F 17/30; G06Q 10/10

(52) U.S. Cl. CPC G06F 17/30864; G06Q 10/105; G06Q 10/10; G06Q 10/1053

(57) ABSTRACT

A system and method for optimizing the allocation of jobs within the job slots for utilization of the maximum limit available on the job slots for the named entity on job portals. Wherein user provides free text inputs on input and output device, free text job input includes at least one information indicating the entity name for which jobs are required to be uploaded on at least one of the job slots available on at least one of the job portals, collecting the pool of jobs for the named entity, transforming the free text job inputs into queue decider form, categorizing the free text inputs as main condition, sub condition, optimizing job upload for that named entity associating to its pool of jobs, based at least on one main condition, sub condition, backfill, reverse backfill or global backfill conditions, to optimize utilization of the maximum job limits available on the job slots for the job portal.

### FIELD OF THE INVENTION

The invention relates to electronic access via communication interface associated with host computer system from a plurality of remote input/output devices enabling the user to provide free text job inputs on web based form via input output device, collecting the pool of jobs for the named entity and using optimization rule creation engine for recognizing the free text job inputs and mapping the free text job inputs with at least one decision rule for managing the allocation of jobs within the job slots by utilization of the maximum job limit available on the job slots available for that named entity.

### BACKGROUND OF THE INVENTION

Various job search vehicles are available to a job searcher or recruiter today on the Internet, e.g. the World Wide Web (web). However, the available resources that can be scrutinized are somewhat limited. There are job crawling engines for crawling over various websites to provide details of jobs. However, the job crawling engines crawl over all the possible job websites and dump high volume of data for further scrutinization for uploading the relevant and high priority jobs on the job slots.

In general, the companies do not want all their jobs to be posted on to the job portal as they may have limited number of job adverts that they can use or they would want to advertise only specific set of jobs. Hence there is a need for a system and method which could enable users prioritizing and selecting jobs as per specific job selection requirements for posting wherein the jobs are prioritized and selected based on various decision rules using optimization rule creation engine.

### OBJECT OF THE PRESENT INVENTION

The object of the present invention is method of optimizing the allocation of jobs within the job slots for utilization of the maximum limit available on the job slots for the named entity on job portals

Further object of the present invention includes recognizing the free text job inputs and mapping the free text job inputs with at least one decision rule for optimizing the utilization of the maximum limit on the job slots available for that named entity on the job portals.

### DETAILED DESCRIPTION OF THE INVENTION

Present invention relates to electronic access via communication interface associated with host computer system from a plurality of remote input/output devices enabling the user to provide free text job inputs on web based form via input output device, collecting the pool of jobs for the named entity and using optimization rule creation engine for recognizing the free text job inputs and mapping the free text job inputs with at least one decision rule for managing the utilization of the maximum limit on the job slots available for that named entity on the job portal.

The present invention includes business process element wherein said system comprising of a host computer, at least one database component associated with the host computer system, and a communication interface for accessing the host computer system from a plurality of remote input/output devices to search and-manage the business process element. In the present invention user has the ease to provide, free text job input which includes at least one information indicating the entity name for which jobs are required to be uploaded on at least one of the job slots available on at least one of the job portals, free text job inputs indicating entity name for which job data are collected as pool of jobs for that entity name. Further the free text job inputs are provided on web form via input output device, which includes describing at least the entity name, queue for the jobs, job types, geographical regions for the jobs, nature of jobs, and time period for the jobs. The input output device includes devices like mobile, iPhone, iPad, Android device, Windows device, Blackberry and any web based devices.

The present invention provides a system and method for searching and aggregating job data from various sources of jobs associating with an entity to collect pool of jobs for that entity. The pool of jobs aggregation method includes crawling on various career sites and other job sources.

In the present invention, the pool of jobs are collected from various sources of jobs, wherein the user enters specific job requirement on the web enabled device or devices; further, said user enters the URL for analyzation (whether it contains specific job or not) on to the web enabled device/devices wherein said device is connected to the portal carries the request for analyzation before crawling on a particular website. Therefore, the inputs provided by the user on web based form is transformed and analysed by the rule creation engine in the manner as described herein.

In one of the embodiment of the present invention the queue decider decides as to whether a particular URL contains specific required job content or not for being crawled based on the type of trainings. Thus the system analyse the words of the URLs against the system trained patterns for generating preliminary score. Further it evaluates based on the knowledge base patterns to generate a total score, based on that the system decides whether the URL needs to be crawled or not. The pool of jobs can be aggregated by threshold test while crawling.

In the present invention once the pool of jobs are collected for the inputs provided by the user, then the system optimizes the utilization of the pool of jobs for the requisite jobs to be uploaded on the available job slots. The Job slots available on the job portals are tagged with Upper limit of job count for each entity name.

In the present invention the user enters specific job inputs on the web form via web enabled device or devices; further, the optimization rule creation engine analyses transforms and maps the free text job inputs with various decision rules and trained patterns that transforms the free text job inputs provided on web based form into queue based job form format categorizing the free text job inputs as main condition, sub condition on the queue based job form format, for optimizing the utilization of job slots connected to the job portal.

In the present invention, the optimization engine consists of decision rules which includes series of conditions to filter the pool of jobs using Main Condition, Sub-Condition, Backfill, reverse backfill, Global Backfill, reverse Global backfill conditions, optimizing job upload for that entity name associating to its pool of jobs, based at least on one main condition, sub condition, backfill, or global backfill conditions. The optimization engine further consists of decision rules which include series of conditions for optimizing the utilization of the maximum limits available for the job slots on the job portal for the named entity. The various decision rules used in the optimization rule creation engine are described as illustration, these decision rules are merely illustrative in nature, there can be many more decision rules associated with the optimization rule creation engine.

The Main Condition includes: at least one primary condition to selects jobs from the pool of jobs, further wherein the main conditions can be used flexibly with the help of “Main Condition decision rule (MCRD)”. The MCDR is used with the help of further decision rules consisting of “OR” & “AND”. The MCDR enables to use more than one condition in a specific order or adding multiple conditions to execute simultaneously.

The Sub-conditions will work only on the selected jobs brought forward by using at least one of the Main Condition. If the main condition is not provided, the Sub-Condition will work on all the available jobs. There can be more than one sub-condition used to select jobs. These can be used flexibly with the help of “Sub-Condition decision rule (SCDR)”. The SCDR is used with the help of further decision rules consisting of “OR” & “AND”. The SCDR enables to use more than one condition in a specific order or adding multiple conditions to execute simultaneously.

The backfill are those residual conditions which trigger when the job slot is not filled with the jobs based on main condition and sub condition criteria, backfill criteria is triggered to fill the job slots which includes filling up of job slots based on residual jobs available in pool of jobs.

The reverse backfills condition triggers as and when the jobs are available in the pool of jobs matching the main condition and sub condition, the jobs earlier filled up on the job slots based on backfill criteria are replaced with jobs subsequently available in the pool of jobs matching mam conditions and sub condition.

Global backfill condition the job slots available for different geographical regions are not filled up based on backfill criteria for that geographical region then the global backfill criteria is triggered to fill up job slot allocation across all regions based on job pools as one common global job pool.

The above job optimization conditions are further explained with the help of following illustration

On the job portal, there is a job slot available for entity X′ the maximum limit of jobs which can be filled up in the above said job slot is 500 jobs. Hence there is a need to optimize the utilization of job slots with various jobs available in the pool of jobs for that entity. The job optimization rule creation engine categorizes the jobs based on the following job optimization conditions.

1. Marketing: 150 If not available backfill with Function “Advertising” jobs

2. Sales: 150 If not available backfill with Function “Business Development” jobs

3. Engineering: 75 If not available backfill with Function “Mechanical” jobs

4. IT: 75 If not available backfill with Function “Project Management” jobs

5. HR: 50 If not available backfill with Function “Legal” jobs

If still jobs are not available then backfill with “accounting” jobs of any country.

The present invention also includes Job Slot Rotation condition wherein the jobs uploaded on job slots can be rotated based on at least one of the job rotation conditions which includes time period indicating the duration for which jobs are required to be displayed on the job slots, upon expiry of the indicated time period the jobs are replaced with further set of jobs. The job rotation condition also includes upload of further set of jobs upon job vacancy filled for the earlier uploaded jobs.

While the system and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A system and method for optimizing the utilization of job slots available for the users on one of the job portals as an interconnection of at least one configurable and nameable business process element; said system comprises:
a. a host computer system;
b. at least one database component associated with the host computer system;
c. a communication interface for accessing the host computer system from a plurality of remote input/output devices for optimizing the utilization of maximum job limits available on the job slots, this business process element, further comprising:
d. a user providing free text job inputs on web based form via input output device, collecting the pool of jobs for the named entity and using optimization rule creation engine for recognizing the free text job inputs and mapping the free text job inputs with at least one job decision rule for managing the allocation of jobs within job slots available on job portals for at least one named entity.

2. A system and method as claimed in claim 1, wherein free text job input includes at-least one information indicating the entity name for which jobs are required to be uploaded on at least one of the job slots available on at least one of the job portals.

3. A system and method as claimed in claim 1, wherein free text job inputs indicate entity name for which job data are collected as pool of jobs for that entity name.

4. A system and method as claimed in claim 1, free text job inputs are provided on web form via input output device, which includes describing at least the entity name, queue for the jobs, job types, geographical regions for the jobs, nature of jobs, time period for the jobs.

5. A system and method as claimed in claim 1, collecting the job data from various sources of job includes aggregating the jobs associated with the named entity from various career sites and job sites for that named entity as pool of jobs.

6. A system and method as claimed in claim 1, wherein each Job slots available on the job portals are tagged with Upper limit of job count that can be posted for each entity name.

7. A system and method as claimed in claim 1, wherein the user enters specific job inputs on the web form via web enabled device or devices; further the optimization rule creation engine analyses transforms and maps the free text job inputs with various decision rules and trained patterns that transforms the free text job inputs provided on web based form into queue based job form format categorizing the free text job inputs as main condition, sub condition on the queue based job form format, for optimizing the utilization of job slots connected to the job portal.

8. A system and method as claimed in claim 1, The optimization engine consisting of decision rules includes series of conditions to filter the pool of jobs using Main Condition, Sub-Condition, Backfill, reverse backfill, Global Backfill, reverse Global backfill conditions, optimizing job posting for that entity name associating to its pool of jobs, based at least on one main condition, sub condition, backfill, or global backfill conditions.

9. A system and method as claimed in claim 1, the Main Condition includes at least one primary condition to selects jobs from the pool of jobs, further the main conditions can be used flexibly with the help of “Main Condition decision rule (MCDR)”. The MCDR is used with the help of further decision rules consisting of “OR” & “AND”. The MCDR enables to use more than one condition in a specific order or adding multiple conditions to execute simultaneously.

10. A system and method as claimed in claim 1, wherein the Sub-conditions will work only on the selected jobs brought forward by using at least one of the Main Condition. If the main condition is not provided, the Sub-Condition will work on all the available jobs. There can be more than one sub-condition used to select jobs. These can be used flexibly with the help of “Sub-Condition decision rule (SCDR)”. The SCDR is used with the help of further decision rules consisting of “OR” & “AND”. The SCDR enables to use more than one condition in a specific order or adding multiple conditions to execute simultaneously.

11. A system and method as claimed in claim 1, wherein backfill job conditions are those residual conditions which trigger when the job slot is not filled up to the available maximum upper limit with the jobs based on main condition and sub condition criteria, backfill criteria is triggered to fill the job slots which includes filling up of job slots based on residual jobs available in the pool of jobs for the named entity.

12. A system and method as claimed in claim 1, wherein reverse backfill condition triggers as and when the jobs are available in the pool of jobs matching the main condition and sub condition, the jobs earlier filled up on the job slots based on backfill criteria are replaced with jobs subsequently available in the pool of jobs matching main conditions and sub condition.

13. A system and method as claimed in claim 1, if the job slots available for different geographical regions are not filled up based on backfill criteria for that geographical region then the global backfill criteria is triggered to fill up job slot allocation across all regions.

14. A system and method for optimizing the allocation of jobs within the job slots for utilization of the maximum limit available on the job slots for the named entity on job portals, Wherein user provides free text inputs on input and output device, free text job input includes at least one information indicating the entity name for which jobs are required to be uploaded on at least one of the job slots available on at least one of the job portals, collecting the pool of jobs for the named entity, transforming the free text job inputs into queue decider form, categorizing the free text inputs as main condition, sub condition, optimizing job upload for that named entity associating to its pool of jobs, based at least on one main condition, sub condition, backfill, reverse backfill or global backfill conditions, job rotation conditions to optimize utilization of the maximum job limits available on the job slots for the job portal.

15. A system and method as claimed in claim 14, optimization rule creation engine also includes Job rotation wherein the jobs uploaded on job slots can be rotated based on at least one of the job rotation conditions which includes time period indicating the duration for which jobs are required to be displayed on the job slots, upon expiry of the indicated time period the jobs are replaced with further set of jobs. The job rotation condition also includes upload of further set of jobs upon job vacancy filled up for the earlier uploaded jobs.
